(19) United States
(12) Patent Application Publication
(10) Pub. No.: US 2008/0034100 A1
(43) Pub. Date: Feb. 7, 2008

(54) SQUELCH BREAK SIGNALING FOR SIP DEVICE

(76) Inventors: Douglas Hall, Raleigh, NC (US); Daniel Floyd, Raleigh, NC (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/833,410

(22) Filed: Aug. 3, 2007

Related U.S. Application Data
(60) Provisional application No. 60/835,567, filed on Aug. 4, 2006.

(51) Int. Cl. G06F 15/177

(52) U.S. Cl. 709/228

(57) ABSTRACT

A squelch break signaling device includes a carrier operated relay cadence timer to set a time limit and a carrier operated relay counter to count the number of times a carrier operated relay transitions from inactive to active and back to inactive within the time limit to provide a session initiation protocol activate signal from the squelch break signaling device when the count of the carrier operated relay counter matches a predetermined number.

### CROSS-REFERENCE TO RELATED APPLICATIONS

This application claims priority under 35 U.S.C. § 119(e) from U.S. provisional application No. 60/835,567 filed on Aug. 4, 2006.

### FIELD OF THE INVENTION

This invention relates generally to hand held radio equipment and more particularly to systems and techniques to interface such hand-held radio equipment to telephony networks.

### BACKGROUND OF THE INVENTION

Hand-held radio equipment is often used in public safety and during an emergency it is often desirable to connect the hand-held radio to a telephone network. In recent times, telephone networks are implementing a new communication technique commonly referred to as Voice over IP, where voice communication is communicated using an Internet Protocol (IP) network. The Voice over IP community has adopted Session Initiation Protocol (SIP) as a protocol of choice for signaling. SIP is a signaling protocol used for establishing sessions in an IP network and is an RFC standard (RFC 3261) understood by those skilled in the art. Using SIP, telephony becomes another web application and integrates with other Internet services.

In public safety applications, it is often desirable to interface hand-held radio equipment to a telephony network through a so called Radio-to-SIP adapter. Such hand-held radio equipment lacks a means of signaling to initiate calls through the SIP network. In the past, DTMF has been used, but many (most) radios do not support DTMF signaling. Other methods require operator intervention of some type.

It is desirable to provide a technique where radio calls to the network using SIP can be automated and do not require operator intervention.

### SUMMARY OF THE INVENTION

In accordance with the present invention, a squelch break signaling device includes a carrier operated relay cadence timer to set a time limit; and a carrier operated relay counter to count the number of times a carrier operated relay transitions from inactive to active and back to inactive within the time limit to provide a session initiation protocol activate signal from the squelch break signaling device when the count of the carrier operated relay counter matches a predetermined number. With such an arrangement, radio calls can be initiated into the telephony network using SIP without requiring operator intervention.

In accordance with a further aspect of the present invention, a method of operating a squelch break signaling device includes the steps of setting a time limit for monitoring transitions of a carrier operated relay, counting the number of transitions from inactive to active and back to inactive within the time limit, and providing a session initiation protocol activate signal from the squelch break signaling device when the count of the carrier operated relay counter matches a predetermined number.

### BRIEF DESCRIPTION OF THE DRAWINGS

The foregoing features of this invention, as well as the invention itself, may be more fully understood from the following description of the drawings in which:

FIG. 1 is a block diagram of a squelch break signaling device according to the invention;

FIG. 2 is a flow chart showing the operation of the squelch break signaling device according to the invention; and

FIG. 3 is a screen shot of the setup screen to set the various settings in the squelch break signaling device according to the invention.

### DETAILED DESCRIPTION OF THE INVENTION

Before providing a detailed description of the invention, it may be helpful to review some terms used to describe the invention.

COR—Carrier Operated Relay, an industry term which is synonymous with squelch, or the signal which is active when the radio is receiving a signal.

COR Cadence Count—the number of times the COR signal has been seen to go from an inactive state to active and back to inactive again.

COR Cadence Time—the window of time during which the specified COR Cadence Count must be observed.

COR Cadence Number—the SIP resource (phone number or IP address) to which a SIP connection will be made when the specified number of COR Cadence Count events are observed within the COR Cadence Time.

One familiar with hand-held radios will appreciate that in normal operation the radio operates in what is known as half duplex mode where a receive signal is received through the receiver and an audio output is provided by the speaker to an user. When the user wishes to talk, a push-to-talk button is depressed which activates the transmitter and the user speaks into the microphone to transmit. For ease of operation, most hand-held radios provide an external microphone and speaker interface so that an external microphone and speaker headset can be used. A base station is similar to a hand-held radio except being configured for a more permanent location. In a typical operation, a plurality of hand-held radios will communicate among each other and with a base station.

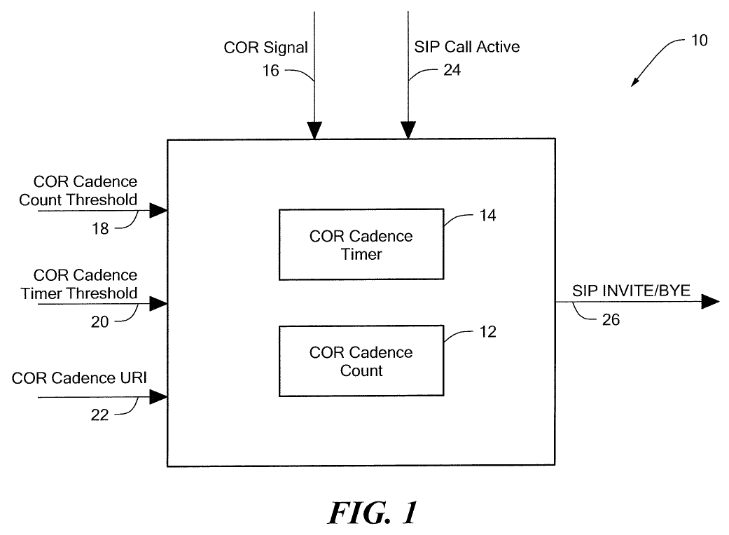

Referring now to FIG. 1, a squelch break signaling device 10 is shown to include a COR counter 12 and a COR cadence timer 14 as well as other circuitry (not shown) to provide an interface between a radio and SIP adapter. It should be appreciated the squelch break signaling device 10 can be a stand alone unit or included as part of the SIP adapter during manufacturing of the SIP adapter. The squelch break signaling device 10 includes a COR signal input 16. The COR signal is active when the radio is receiving an RF signal and inactive when not. The COR signal can either be supplied directly by the radio or derived from the audio from the radio using voice detection algorithms. The squelch break signaling device 10 further includes a COR cadence count threshold signal input 18. The COR cadence count threshold signal provides the number of times the COR signal should transition from inactive to active and back to inactive state before performing an action. The squelch break signaling device 10 still further includes a COR Cadence Timer Threshold signal input 20. The COR Cadence Timer Threshold signal provides the amount of clock time within which the COR Cadence Count Threshold signal transitions of the COR signal should occur before performing an action. The squelch break signaling device 10 still further includes a COR cadence URI signal input 22. The COR cadence URI signal provides the SIP URI (SIP addressing schema as defined in RFC 3261 standard) to initiate a call. The squelch break signaling device 10 still further includes a SIP call active signal input 24. The SIP call active signal is active when a call is already in progress and inactive when not. The squelch break signaling device 10 also includes a SIP invite/bye signal output 26. The SIP invite/bye signal provides an SIP invite or bye request to either initiate or end a call.

The squelch break signaling device 10 is disposed between the local radio and the SIP adapter that provides an interface into the IP network that the Voice over IP communication application is operating.

It should be appreciated that a COR signal may be initiated in a receiver by pressing the push-to-talk (PTT) button on a distant transmitter. Pressing the PTT button a specified number of times (the COR Cadence Count) within a specified time (the COR Cadence Time) initiates a connection to the specified SIP telephony network resource. This allows a radio with no other signaling ability (DTMF or otherwise) to initiate a call without operator intervention. The use of this method in a Radio-to-SIP adapter is unique.

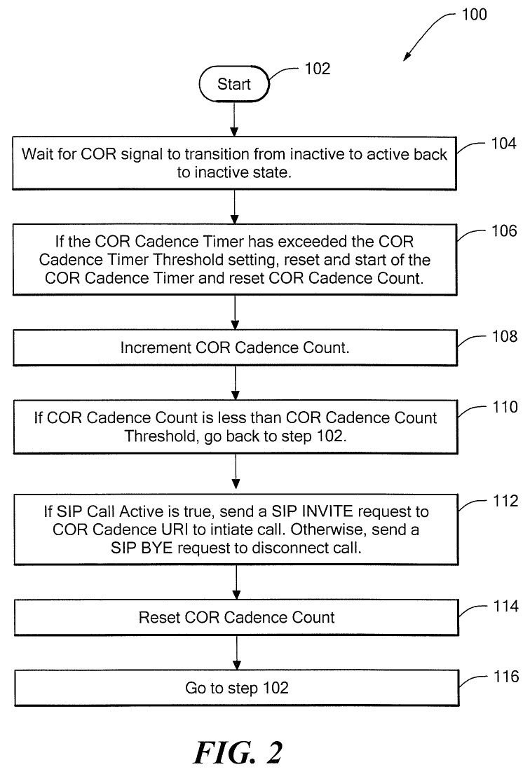

Referring now to FIG. 2 a flow chart 100 is shown describing the operation of the squelch break signaling device 10 in more detail starting at step 102. As shown in step 104, the squelch break signaling device 10 monitors the COR signal input 16 for the signal to transition from inactive to active back to inactive state. As shown in step 106, if the COR Cadence Timer 14 has exceeded the COR Cadence Timer Threshold setting, then a reset and a start of the COR Cadence Timer 14 and reset COR Cadence Counter 12 is performed. As shown in step 108, an increment COR Cadence Count is performed. as shown in step 110, if COR Cadence Count is less than COR Cadence Count Threshold, go back to 102. If SIP Call Active is true, send a SIP INVITE request to COR Cadence URI to initiate call, otherwise, send a SIP BYE request to disconnect call as shown in step 112. As shown in step 114, a reset COR Cadence Counter is performed. As shown in step 116, go to step 102 is performed. The above operation is repeated to initiate and disconnect calls as needed.

It should be appreciated that a flowchart represents computer software instructions or groups of instructions. Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

It should now be appreciated, the squelch break signaling device 10 monitors the squelch signal from the radio and initiates a specified SIP action based on the cadence of the squelch signal. This allows a user to click their microphone push-to-talk (PTT) button a specified number of times in a specified timeframe and initiate a telephony connection through the network via SIP with no operator intervention required.

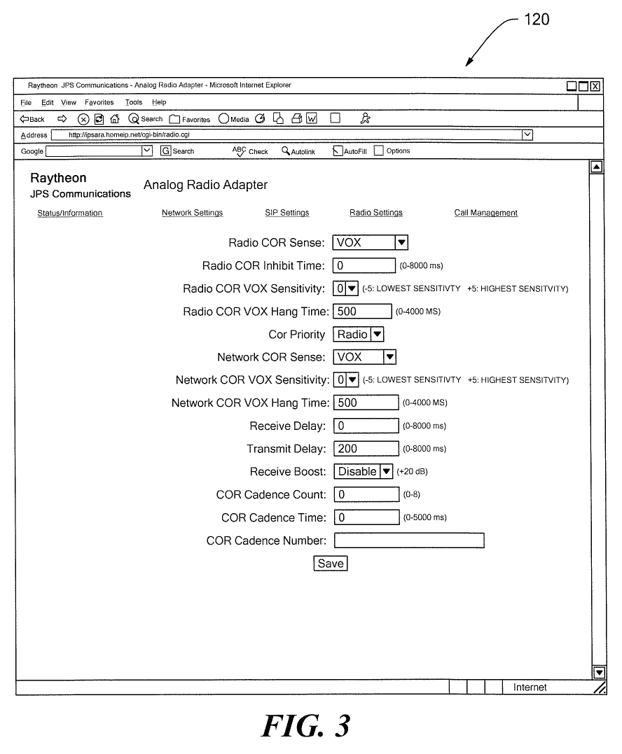

Referring now to FIG. 3, a computer screen shot 120 of the analog radio adapter configuration screen for the radio interface is shown. The last three configuration items show the COR Cadence Count, COR Cadence Time, and the COR Cadence Number where such settings are provided using the digital computer interface to configure the squelch break signaling device 10.

It should now be appreciated a squelch break signaling device according to the present invention includes a carrier operated relay input to provide a signal indicative that a receiver is receiving an RF signal; a carrier operated relay cadence count threshold signal input to provide a signal indicative of the number of times a carrier operated relay signal should transition from inactive to active and back to inactive before performing an action; a carrier operated relay cadence timer threshold signal input to provide a signal indicative of an amount of clock time within which the carrier operated relay signal should transition before performing an action; a carrier operated relay cadence URI signal input to provide a SIP URI; a carrier operated relay cadence timer to set a time limit; and a carrier operated relay counter to count the number of times a carrier operated relay transitions from inactive to active and back to inactive within the time limit to provide a session initiation protocol activate signal from the squelch break signaling device when the count of the carrier operated relay counter matches the number provided by the carrier operated relay cadence count threshold signal.

Having described the preferred embodiment of the invention, it will now become apparent to one of ordinary skill in the art that other embodiments incorporating their concepts may be used. It is felt therefore that these embodiments should not be limited to disclosed embodiments but rather should be limited only by the spirit and scope of the appended claims.

What is claimed is:

1. A squelch break signaling device comprising:
a carrier operated relay cadence timer to set a time limit; and
a carrier operated relay counter to count the number of times a carrier operated relay transitions from inactive to active and back to inactive within the time limit to provide a session initiation protocol activate signal from the squelch break signaling device when the count of the carrier operated relay counter matches a predetermined number.

2. The squelch break signaling device as recited in claim 1 wherein the squelch break signaling device is integrated with a session initiation protocol adapter.

3. The squelch break signaling device as recited in claim 1 wherein the predetermined number is greater than two but less than seven.

4. A method of operating a squelch break signaling device comprising:
setting a time limit for monitoring transitions of a carrier operated relay;
counting the number of transitions from inactive to active and back to inactive within the time limit; and
providing a session initiation protocol activate signal from the squelch break signaling device when the count of the carrier operated relay counter matches a predetermined number.

5. The method as recited in claim 4 wherein the predetermined number is greater than two but less than seven.

6. A squelch break signaling device comprising:
a carrier operated relay input to provide a signal indicative that a receiver is receiving an RF signal;
a carrier operated relay cadence count threshold signal input to provide a signal indicative of the number of times a carrier operated relay signal should transition from inactive to active and back to inactive before performing an action;
a carrier operated relay cadence timer threshold signal input to provide a signal indicative of an amount of clock time within which the carrier operated relay signal should transition before performing an action;
a carrier operated relay cadence URI signal input to provide a SIP URI;
a carrier operated relay cadence timer to set a time limit; and
a carrier operated relay counter to count the number of times a carrier operated relay transitions from inactive to active and back to inactive within the time limit to provide a session initiation protocol activate signal from the squelch break signaling device when the count of the carrier operated relay counter matches the number provided by the carrier operated relay cadence count threshold signal.
